(19) United States
(12) Patent Application Publication
(10) Pub. No.: US 2025/0199430 A1
(43) Pub. Date: Jun. 19, 2025

(54) TONER

(71) Applicant: CANON KABUSHIKI KAISHA, Tokyo (JP)

(72) Inventors: KENJI AOKI, Shizuoka (JP); SHUHEI IWASAKI, Kanagawa (JP); YUKI MASUDA, Shizuoka (JP); KOKI INOUE, Shizuoka (JP)

(21) Appl. No.: 18/975,943

(22) Filed: Dec. 10, 2024

(30) Foreign Application Priority Data
Dec. 14, 2023 (JP) 2023-210834

(51) Int. Cl. G03G 9/093

(52) U.S. Cl. CPC G03G 9/09364; G03G 9/09314; G03G 9/09392

(57) ABSTRACT

A toner includes toner particles containing a resin component. The toner particles contain, as the resin component, a crystalline vinyl resin having a unit (a) represented by formula (1). The resin component contains the unit (a) in an amount of 15.0 mass % or more and 40.0 mass % or less based on the mass of the resin component. The content of the unit (a) in a component separated by gradient LC analysis of an acetonitrile/chloroform eluted component of chloroform soluble matter W of the toner particles and the storage elastic modulus at 100° C. have specific relationships.

### BACKGROUND

### Technical Field

The present disclosure relates to a toner.

### Description of the Related Art

In the field of electrophotographic apparatuses, energy saving has been considered a major technical challenge, and a significant reduction in the quantity of heat associated with a fusing device has been studied. Regarding toners, there has been an increasing need for what is called “low-temperature fixability”, which enables fixing at low energy.

As a method for enabling fixing at low temperature, International Publication No. 2013/047296 discloses a toner with a plasticizer added. The plasticizer increases the softening rate of a binder resin while maintaining the glass transition temperature (Tg) of the toner, and can improve low-temperature fixability. However, since the toner softens through a process in which the binder resin is plasticized after the plasticizer has melted, there is a limit to how fast the toner can melt, and thus further improvement in low-temperature fixability is desired.

Accordingly, methods using a crystalline resin as a binder resin have been studied. Amorphous resins, which are commonly used as binder resins for toners, do not exhibit distinct endothermic peaks in differential scanning calorimetry (DSC), but when a toner contains a crystalline resin component, an endothermic peak (melting point) appears in DSC.

Crystalline resins, in which molecular chains are regularly arranged, have the property that they hardly soften at temperatures lower than their melting point. On the other hand, at temperatures higher than their melting point, crystals rapidly melt, which is accompanied by a rapid decrease in viscosity. Crystalline resins, which have such an excellent sharp melt property, are attracting attention as materials useful for improving the low-temperature fixability of toners.

In some toners, a crystalline vinyl resin having long-chain alkyl groups as side chains in its molecule is used as a crystalline resin. In general, a crystalline vinyl resin has a structure in which long-chain alkyl groups as side chains are bonded to the main chain, and crystallization of the long-chain alkyl groups as side chains makes the crystalline vinyl resin act as a crystalline resin.

Japanese Patent Laid-Open No. 2022-162968 discloses, as a toner in which a crystalline vinyl resin is used, a toner in which a crystalline vinyl resin obtained by copolymerizing a polymerizable monomer having a long-chain alkyl group and an amorphous polymerizable monomer having a different SP value is used.

However, crystalline vinyl resins have a disadvantage in that their viscosity tends to decrease at high temperatures, so that hot offset is likely to occur. To overcome this disadvantage, Japanese Patent Laid-Open No. 2021-096463 discloses a toner in which a domain-matrix structure including an amorphous resin in addition to a crystalline vinyl resin is formed.

However, it has turned out that such a toner in which a crystalline vinyl resin and an amorphous resin are used in combination tends to experience a decrease in gloss at the time of fixing. At the time of fixing, the crystalline vinyl resin turns into a molten state to undergo a rapid decrease in viscosity. By contrast, the amorphous resin is not in a molten state or, if molten, becomes less viscous slowly, so that areas with relatively high viscosity and low viscosity are formed inside the toner. As a result of this, hot offset is likely to occur, and minute concavities and convexities are formed on the surface of a fixed image, thus resulting in a decrease in gloss. It has been found that this phenomenon notably occurs in a low-temperature fixation and high-speed printing system in which the molten states of resins tend to be different from each other.

The present disclosure is directed to providing a toner excellent in low-temperature fixability and hot-offset resistance.

### SUMMARY

The present disclosure provides a toner including toner particles containing a resin component, wherein the resin component contains a crystalline vinyl resin having a unit (a) represented by formula (1),

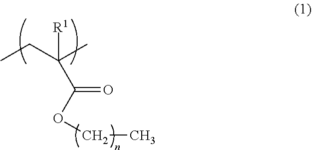

in formula (1), R¹ represents a hydrogen atom or a methyl group, and n represents an integer of 15 to 35, and the resin component contains the unit (a) in an amount of 15.0 mass % or more and 40.0 mass % or less based on a mass of the resin component, when the toner particles are subjected to Soxhlet extraction using chloroform for 18 hours to obtain chloroform soluble matter, from which a component having a molecular weight of 2,000 or less is removed by recycling HPLC to obtain chloroform soluble matter W, for the chloroform soluble matter W, acetonitrile as a poor solvent and chloroform as a good solvent are used while a mobile phase is linearly changed from 100 vol % acetonitrile to 100 vol % chloroform, and an eluted component is subjected to gradient LC analysis, a plurality of local maximal values are present in a graph in which a horizontal axis represents a chloroform percentage (vol %) in the mobile phase, and a vertical axis represents a signal intensity (μA) of the eluted component detected using a charged particle detector, when, of a local maximal value with a highest intensity and a local maximal value with a second highest intensity among the plurality of local maximal values, a local maximal value at which the chloroform percentage in the mobile phase is smaller is a local maximal value PA, and a local maximal value at which the chloroform percentage in the mobile phase is larger is a local maximal value PB, a local minimum value with a lowest intensity present between the local maximal value PA and the local maximal value PB is a local minimum value BAB, a chloroform percentage at the local minimum value BAB is VAB vol % (20.0<VAB<95.0), a component whose chloroform percentage in the mobile phase is 20.0 vol % or more and less than VAB vol % is a component A, and a component whose chloroform percentage in the mobile phase is VAB vol % or more and 95.0 vol % or less is a component B, the resin component contains the component B in an amount of 40.0 mass % or more and 80.0 mass % or less based on the mass of the resin component, when a content of the unit (a) in the chloroform soluble matter W is WC mass %, and a content of the unit (a) in the component B is WB mass %, WC and WB satisfy formula (2),

WB/WC≥0.70 (2), and
when a storage elastic modulus of the toner particles at 100° C. is G′(T), and a storage elastic modulus of the component B at 100° C. is G′(B), G′(T) and G′(B) satisfy formulas (3) and (4),

$$5. \times {10}^{3} Pa \leq {G}^{′} ( T ) \leq 1. \times {10}^{5} Pa \qquad ( 3 )$$

$$2. \times {10}^{3} Pa \leq {G}^{′} ( T ) - {G}^{′} ( B ) \leq 6. \times {10}^{3} Pa . \qquad ( 4 )$$

Further features of the present disclosure will become apparent from the following description of exemplary embodiments.

### DESCRIPTION OF THE EMBODIMENTS

In the present disclosure, the phrases “XX or more and YY or less” and “XX to YY” representing numerical ranges each mean a numerical range including its endpoints, that is, the lower limit and the upper limit, unless otherwise specified. When numerical ranges are described in stages, the upper limit of each numerical range may be combined with the lower limit of any other numerical range.

The term “(meth)acrylate” refers to an acrylate and/or a methacrylate.

The term “monomer unit” refers to a reacted form of a monomeric substance in a polymer. For example, in a polymer, one carbon-carbon bond section in a main chain formed by polymerization of a polymerizable monomer is one unit. The polymerizable monomer can be represented by, for example, formula (C) below.

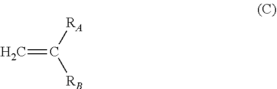

In formula (C) above, R_{A} represents a hydrogen atom or an alkyl group (preferably an alkyl group having 1 to 3 carbon atoms, more preferably a methyl group), and R_{B} represents a monovalent group.

The term “crystalline resin” refers to a resin that exhibits a distinct endothermic peak in differential scanning calorimetry (DSC).

The present inventors have found that the above-described disadvantage can be solved by appropriately controlling the viscoelasticity of a resin component in toner particles that contains a crystalline vinyl resin in a large amount and the viscoelasticity of the toner particles (the entire toner particles).

A toner according to the present disclosure is a toner including toner particles containing a resin component,
wherein the toner particles contain, as the resin component, a crystalline vinyl resin having a unit (a) represented by formula (1) below,

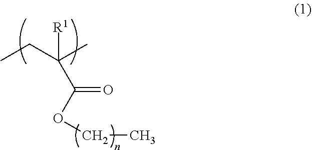

in formula (1) above, R¹ represents a hydrogen atom or a methyl group, and n represents an integer of 15 to 35, and the resin component contains the unit (a) in an amount of 15.0 mass % or more and 40.0 mass % or less based on a mass of the resin component,
when the toner particles are subjected to Soxhlet extraction using chloroform for 18 hours to obtain chloroform soluble matter, from which a component having a molecular weight of 2,000 or less is removed by recycling HPLC to obtain chloroform soluble matter W,
for the chloroform soluble matter W, acetonitrile as a poor solvent and chloroform as a good solvent are used while a mobile phase is linearly changed from 100 vol % acetonitrile to 100 vol % chloroform, and an eluted component is subjected to gradient LC analysis,
a plurality of local maximal values are present in a graph in which a horizontal axis represents a chloroform percentage (vol %) in the mobile phase, and
a vertical axis represents a signal intensity (μA) of the eluted component detected using a charged particle detector,
when, of a local maximal value with a highest intensity and a local maximal value with a second highest intensity among the plurality of local maximal values, a local maximal value at which the chloroform percentage in the mobile phase is smaller is a local maximal value PA, and
a local maximal value at which the chloroform percentage in the mobile phase is larger is a local maximal value PB, a local minimum value with a lowest intensity present between the local maximal value PA and the local maximal value PB is a local minimum value BAB,
a chloroform percentage at the local minimum value BAB is VAB vol % (20.0<VAB<95.0),
a component whose chloroform percentage in the mobile phase is 20.0 vol % or more and less than VAB vol % is a component A, and
a component whose chloroform percentage in the mobile phase is VAB vol % or more and 95.0 vol % or less is a component B,
the resin component contains the component B in an amount of 40.0 mass % or more and 80.0 mass % or less based on the mass of the resin component,
when a content of the unit (a) in the chloroform soluble matter W is WC mass %, and
a content of the unit (a) in the component B is WB mass %,
WC and WB satisfy formula (2) below,

WB/WC≥0.70 (2), and
when a storage elastic modulus of the toner particles at 100° C. is G′(T), and
a storage elastic modulus of the component B at 100° C. is G′(B),
G′(T) and G′(B) satisfy formulas (3) and (4) below,

$$5. \times {10}^{3} Pa \leq {G}^{′} ( T ) \leq 1. \times {10}^{5} Pa \qquad ( 3 )$$

$$2. \times {10}^{3} Pa \leq {G}^{′} ( T ) - {G}^{′} ( B ) \leq 6. \times {10}^{3} Pa . \qquad ( 4 )$$

The toner according to the present disclosure is a toner including toner particles containing a resin component. The toner particles contain, as the resin component, a crystalline vinyl resin having a unit (a) represented by formula (1) below.

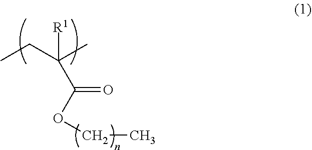

In formula (1) above, R¹ represents a hydrogen atom or a methyl group, and n represents an integer of 15 to 35.

The unit (a) represents a unit having a long-chain alkyl group. Due to the presence of the unit (a), the resin component acts as a crystalline vinyl resin. When n in formula (1) above is 15 to 35, the crystallinity of the crystalline vinyl resin is readily exhibited. n is preferably an integer of 17 to 29.

The resin component according to the present disclosure contains the unit (a) in an amount of 15.0 mass % or more and 40.0 mass % or less based on the mass of the resin component. When the amount of the unit (a) is in this range, the amount of crystals in the toner is appropriate, and good low-temperature fixability is provided. When the amount of the unit (a) is less than 15.0 mass %, the amount of crystals in the toner is small, thus resulting in low low-temperature fixability. When the amount of the unit (a) is more than 40.0 mass %, the amount of crystals in the toner (the toner particles) is excessively large, and the melt viscosity of the toner at the time of fixing is excessively low, thus resulting in low hot-offset resistance. A preferred range of the unit (a) in the resin component is 20.0 mass % or more and 35.0 mass % or less.

The gradient LC analysis will be described. The gradient LC analysis is carried out in the following manner unless otherwise specified.

The toner particles are subjected to Soxhlet extraction using a chloroform solvent for 18 hours to obtain soluble matter, from which a component having a molecular weight of 2,000 or less is removed by recycling HPLC to obtain chloroform soluble matter W, which is used as a specimen. For the chloroform soluble matter extracted from the toner particles, acetonitrile as a poor solvent and chloroform as a good solvent are used while a mobile phase is linearly changed from 100 vol % acetonitrile to 100 vol % chloroform.

The eluted component obtained during this change is subjected to gradient LC analysis.

As a result, a graph in which the horizontal axis represents the chloroform percentage (vol %) in the mobile phase, and the vertical axis represents the signal intensity (μA) of the eluted component detected using a charged particle detector is obtained. Acetonitrile is a solvent with high polarity, and components with high polarity are eluted first. As the chloroform percentage increases, components with low polarity are gradually eluted. Therefore, in this analysis, separation according to the polarity in the chloroform soluble matter W can be performed. The toner according to the present disclosure exhibits a plurality of local maximal values in this analysis. Of a local maximal value with a highest intensity and a local maximal value with a second highest intensity among the plurality of local maximal values, a local maximal value at which the chloroform percentage in the mobile phase is smaller, that is, a local maximal value at which the polarity is relatively high, is a local maximal value PA. A local maximal value at which the chloroform percentage in the mobile phase is larger, that is, a local maximal value at which the polarity is relatively low, is a local maximal value PB. A local minimum value with a lowest intensity present between the local maximal value PA and the local maximal value PB is a local minimum value BAB, and a chloroform percentage at the local minimum value BAB is VAB vol % (20.0<VAB<95.0). A component whose chloroform percentage in the mobile phase is 20.0 vol % or more and less than VAB vol % is a component A, and a component whose chloroform percentage in the mobile phase is VAB vol % or more and 95.0 vol % or less is a component B.

The resin component according to the present disclosure contains the component B in an amount of 40.0 mass % or more and 80.0 mass % or less based on the mass of the resin component. When a content of the unit (a) in the chloroform soluble matter W is WC mass %, and a content of the unit (a) in the component B is WB mass %, WC and WB satisfy formula (2) below.

$$WB / WC \geq 0.7 \qquad ( 2 )$$

The unit (a) has relatively low polarity because of having a long-chain alkyl group. Thus, satisfying formula (2) above means that the component A and the component B are clearly separated from each other, and most of the unit (a) exhibiting crystallinity, that is, the crystalline vinyl resin, is present in the component B.

The component B being contained in an amount of 40.0 mass % or more and 80.0 mass % or less based on the mass of the resin component means that a component having crystallinity is present in an appropriate amount, whereby good low-temperature fixability is provided. When the amount of the component B is less than 40.0 mass %, the amount of the component that exhibits crystallinity is too small, thus resulting in poor low-temperature fixability. When the amount of the component B is more than 80.0 mass %, the amount of the component that exhibits crystallinity is too large, thus resulting in low hot-offset resistance. A preferred range of the component B in the resin component is 50.0 mass % or more and 75.0 mass % or less, more preferably 55.0 mass % or more and 70.0 mass % or less. The content of the component B in the resin component can be controlled by the content of the crystalline vinyl resin in the resin component, the content of the unit (a) in the crystalline vinyl resin, etc.

In the toner according to the present disclosure, when a storage elastic modulus of the toner particles at 100° C. is G′(T), G′(T) satisfies formula (3) below.

$$5. \times {10}^{3} Pa \leq {G}^{′} ( T ) \leq 1. \times {10}^{5} Pa \qquad ( 3 )$$

The storage elastic modulus at 100° C. indicates the viscosity of the toner particles after melting, and when G′(T) is in the above range, penetration of the toner particles into paper and release from a fixing film can be effectively achieved, and good low-temperature fixability is provided. When G′(T) is less than 5.0×10³ Pa, the viscosity of the toner particles after melting is too low, and thus toner migration to a fixing member (e.g., a fixing film) is likely to occur at the time of fixing, resulting in low hot-offset resistance. When G′(T) is more than 1.0×10⁵ Pa, the viscosity of the toner particles after melting is too high, and thus penetration of the toner particles into paper is less likely to occur at the time of fixing, resulting in poor low-temperature fixability. A preferred range of G′(T) is 8.0×10³ Pa or more and 8.0×10⁴ Pa or less, more preferably 9.0×10³ Pa or more and 5.0×10⁴ Pa or less. G′(T) can be controlled by the content of the unit (a) in the resin component in the toner particles, the molecular weight of the resin component, the content of the component B, etc.

In the toner particles according to the present disclosure, when a storage elastic modulus of the component B at 100° C. is G′(B), formula (4) below is satisfied.

$$2. \times {10}^{3} Pa \leq {G}^{′} ( T ) - {G}^{′} ( B ) \leq 6. \times {10}^{3} Pa \qquad ( 4 )$$

As described above, most of the unit (a) exhibiting crystallinity in the resin component is present in the component B. Therefore, the storage elastic modulus of the component B at 100° C. is relatively low compared to that of the toner particles. On the other hand, if components whose storage elastic moduli at 100° C. are significantly different are present in the toner particles, areas with relatively high viscosity and low viscosity are formed inside the toner particles at the time of fixing, so that minute concavities and convexities are formed on the surface of a fixed image, thus resulting in a decrease in gloss. This phenomenon notably occurs in a low-temperature fixation and high-speed printing system in which the molten states of resins tend to be different from each other.

When formula (4) above is satisfied, the relative difference in storage elastic modulus is in an appropriate range, and thus a high gloss can be achieved even at the time of low-temperature fixation at high speed.

When G′(T)-G′(B) is less than 2.0×10³ Pa, penetration into paper is less likely to occur at the time of fixing, resulting in a fixed image with low abrasion resistance. When G′(T)-G′(B) is more than 6.0×10³ Pa, the gloss at the time of low-temperature fixation at high speed is low.

G′(T)-G′(B) can be controlled by the content of the crystalline vinyl resin accounting for most of the component B, the ratio of the unit (a) in the crystalline vinyl resin, the molecular weight of the crystalline vinyl resin, etc.

The component B according to the present disclosure will be described.

In the component B, most of the crystalline vinyl resin is present as described above.

The component B can contain the unit (a) in an amount of 25.0 mass % or more and 50.0 mass % or less based on the mass of the component B. Within this range, the content of the unit (a) in the toner particles tends to be in an appropriate range, and the low-temperature fixability and the hot-offset resistance tend to be well-balanced. The amount of the unit (a) is preferably 30.0 mass % or more and 45.0 mass % or less.

In the component B, the weight-average molecular weight (Mw) of tetrahydrofuran (THF) soluble matter determined by gel permeation chromatography (GPC) is preferably 30,000 or more and 200,000 or less. When the Mw is in this range, G′(T)-G′(B) tends to be in an appropriate range. A preferred range of the Mw is 40,000 or more and 180,000 or less, more preferably 60,000 or more and 150,000 or less.

The crystalline vinyl resin according to the present disclosure will be described.

The crystalline vinyl resin is a component most of which is present in the component B as described above.

The crystalline vinyl resin contains the unit (a), and one example of a method for introducing the unit (a) is to polymerize a (meth)acrylate as listed below. Examples include stearyl (meth)acrylate, nonadecyl (meth)acrylate, eicosyl (meth)acrylate, heneicosanyl (meth)acrylate, behenyl (meth)acrylate, lignoceryl (meth)acrylate, ceryl (meth)acrylate, octacosyl (meth)acrylate, myricyl (meth)acrylate, dotriacontyl (meth)acrylate, and 2-decyltetradecyl (meth)acrylate.

The unit (a) contained in the crystalline vinyl resin may be of one single type or two or more types.

The percentage content of the unit (a) in the crystalline vinyl resin is preferably 40.0 mass % or more and 90.0 mass % or less, more preferably 45.0 mass % or more and 85.0 mass % or less, still more preferably 50.0 mass % or more and 80.0 mass % or less. Within this range, a better balance between low-temperature fixability and hot-offset resistance is provided.

The crystalline vinyl resin may have another unit in addition to the unit (a). One example of a method for introducing another unit into the crystalline vinyl resin is to polymerize any of the above (meth)acrylates and another vinyl monomer.

Examples of the other vinyl monomer include the following:
styrene, α-methylstyrene, and (meth)acrylates such as methyl (meth)acrylate, ethyl (meth)acrylate, n-butyl (meth)acrylate, t-butyl (meth)acrylate, and 2-ethylhexyl (meth)acrylate;
monomers having a urea group, such as monomers obtained by reacting amines having 3 to 22 carbon atoms [e.g., primary amines (e.g., n-butylamine, t-butylamine, propylamine, and isopropylamine), secondary amines (e.g., di-n-ethylamine, di-n-propylamine, and di-n-butylamine), aniline, and cyclohexylamine] with isocyanates having an ethylenically unsaturated bond and 2 to 30 carbon atoms by known methods;
monomers having a carboxy group, such as methacrylic acid, acrylic acid, and 2-carboxyethyl (meth)acrylate;
monomers having a hydroxy group, such as 2-hydroxyethyl (meth)acrylate and 2-hydroxypropyl (meth)acrylate;
monomers having an amide group, such as acrylamide and monomers obtained by reacting amines having 1 to 30 carbon atoms with carboxylic acids having an ethylenically unsaturated bond and 2 to 30 carbon atoms (e.g., acrylic acid and methacrylic acid) by known methods; and
monomers having a lactam structure, such as N-vinyl-2-pyrolidone.

Of these, monomers having a lactam structure are preferred, monomers having a five-membered ring lactam structure are preferred, and N-vinyl-2-pyrolidone is more preferred. The presence of a unit having a lactam structure helps improve the affinity between the crystalline vinyl resin and paper to provide a fixed image with improved abrasion resistance.

The percentage content of the unit having a lactam structure in the crystalline vinyl resin is preferably 2.0 mass % or more and 15.0 mass % or less.

The crystalline vinyl resin can also be obtained by copolymerizing a (meth)acrylate for introducing the unit (a) with another vinyl monomer to synthesize a crystalline vinyl resin and then further reacting another vinyl monomer by hydrogen abstraction reaction. The hydrogen abstraction reaction is a reaction in which a hydrogen atom bonded to a carbon atom is abstracted to generate a radical, and another vinyl monomer can be further reacted from the generated radical. This enables formation of a state in which the unit (a) in the crystalline vinyl resin is more assembled in a molecule and helps increase crystallinity. It also helps satisfy formula (4) above.

In the crystalline vinyl resin, the weight-average molecular weight (Mw) of tetrahydrofuran (THF) soluble matter determined by gel permeation chromatography (GPC) is preferably 30,000 or more and 200,000 or less. When the Mw is in this range, G′(T)-G′(B) tends to be in an appropriate range. A preferred range of the Mw is 40,000 or more and 180,000 or less, more preferably 60,000 or more and 150,000 or less.

The content of the crystalline vinyl resin in the toner particles according to the present disclosure is preferably 30.0 mass % or more and 80.0 mass % or less based on the mass of the toner particles. Within this range, the component having crystallinity of the toner particles tends to be present in an appropriate amount, and low-temperature fixability and hot-offset resistance tends to be simultaneously achieved. The content of the crystalline vinyl resin is more preferably 40.0 mass % or more and 75.0 mass % or less, still more preferably 50.0 mass % or more and 70.0 mass % or less.

In the toner particles according to the present disclosure, the melting point derived from the crystalline vinyl resin in differential scanning calorimetry (DSC) is preferably 50° C. or higher and 80° C. or lower. When the melting point derived from the crystalline vinyl resin is in this range, low-temperature fixability tends to be improved. A preferred range of the melting point is 55° C. or higher and 75° C. or lower, and a more preferred range is 57° C. or higher and 70° C. or lower.

The component A according to the present disclosure will be described.

The component A is a component that is more polar than the component B, and most of the crystalline vinyl resin is present in the component B; thus, most of other resin components is present in the component A. Examples of the other resin components include an amorphous resin.

The resin component can contain the component A in an amount of 10.0 mass % or more and 60.0 mass % or less based on the mass of the resin component. Within this range, the component having crystallinity of the toner particles tends to be present in an appropriate amount, and low-temperature fixability and hot-offset resistance tends to be simultaneously achieved. The amount of the component A is more preferably 15.0 mass % or more and 55.0 mass % or less, still more preferably 20.0 mass % or more and 50.0 mass % or less.

In the component A, the weight-average molecular weight (Mw) of tetrahydrofuran (THF) soluble matter determined by gel permeation chromatography (GPC) is preferably 20,000 or more and 200,000 or less, more preferably 25,000 or more and 150,000 or less.

The amorphous resin is, for example, a vinyl resin, a polyester resin, a polyurethane resin, or an epoxy resin, and may be a vinyl resin or a polyester resin.

When the amorphous resin is a vinyl resin, the vinyl monomer usable for the crystalline vinyl resin can be used. The (meth)acrylate for introducing the unit (a) can also be used as long as the amorphous resin does not exhibit crystallinity.

What is called a crosslinking agent having a plurality of vinyl groups per monomer can also be used. Examples of the crosslinking agent include the following: diethylene glycol diacrylate, triethylene glycol diacrylate, tetraethylene glycol diacrylate, polyethylene glycol diacrylate, 1,6-hexanediol diacrylate, neopentyl glycol diacrylate, tripropylene glycol diacrylate, polypropylene glycol diacrylate, 2,2′-bis(4-(acryloxydiethoxy)phenyl)propane, trimethylolpropane triacrylate, tetramethylolmethane tetraacrylate, ethylene glycol dimethacrylate, diethylene glycol dimethacrylate, triethylene glycol dimethacrylate, tetraethylene glycol dimethacrylate, polyethylene glycol dimethacrylate, 1,3-butylene glycol dimethacrylate, 1,6-hexanediol dimethacrylate, neopentyl glycol dimethacrylate, polypropylene glycol dimethacrylate, 2,2′-bis(4-(methacryloxydiethoxy)phenyl)propane, 2,2′-bis(4-(methacryloxypolyethoxy)phenyl)propane, trimethylolpropane trimethacrylate, tetramethylolmethane tetramethacrylate, divinylbenzene, divinylnaphthalene, divinyl ether, and 4,4′-divinylbiphenyl.

When the amorphous resin is a polyester resin, a polyester resin obtainable by a reaction between a polycarboxylic acid with a valence of 2 or more and a polyhydric alcohol can be used.

Examples of the polycarboxylic acid include the following: dibasic acids such as succinic acid, adipic acid, sebacic acid, phthalic acid, isophthalic acid, terephthalic acid, malonic acid, and dodecenylsuccinic acid, and anhydrides and lower alkyl esters thereof; aliphatic unsaturated dicarboxylic acids such as maleic acid, fumaric acid, itaconic acid, and citraconic acid; and 1,2,4-benzenetricarboxylic acid, 1,2,5-benzenetricarboxylic acid, and anhydrides and lower alkyl esters thereof. These may be used alone or in combination of two or more.

Examples of the polyhydric alcohol include the following: alkylene glycols (ethylene glycol, 1,2-propylene glycol, and 1,3-propylene glycol); alkylene ether glycols (polyethylene glycol and polypropylene glycol); alicyclic diols (1,4-cyclohexanedimethanol); bisphenols (bisphenol A); and adducts of alicyclic diols with alkylene oxides (ethylene oxide and propylene oxide). The alkyl moieties of the alkylene glycols and alkylene ether glycols may be linear or branched. Further examples include glycerol, trimethylolethane, trimethylolpropane, and pentaerythritol. These may be used alone or in combination of two or more.

For the purpose of adjusting the acid value or hydroxyl value, a monovalent acid such as acetic acid or benzoic acid or a monohydric alcohol such as cyclohexanol or benzyl alcohol can also be used as needed.

As a method for producing the polyester resin, for example, a transesterification method and a direct polycondensation method can be used alone or in combination.

The resin component according to the present disclosure contains chloroform insoluble matter, and the content of the chloroform insoluble matter is preferably 3.0 mass % or more and 15.0 mass % or less based on the mass of the resin component. Within this range, the toner tends to be provided with elasticity effectively, and low-temperature fixability and hot-offset resistance tends to be simultaneously achieved.

The toner particles according to the present disclosure may have a core-shell structure including a core particle containing the resin and a shell covering the core particle. The resin forming the shell is preferably a vinyl resin or a polyester resin from the viewpoint of charging stability, more preferably an amorphous polyester resin. The shell need not necessarily cover the entire core, and the core may be partially exposed. As the vinyl resin and the polyester resin constituting the shell, the vinyl resin and the polyester resin usable for the component A and the component B described above can be used.

The toner particles may contain a wax. The wax is at least one selected from the group consisting of a hydrocarbon wax and an ester wax. The use of a hydrocarbon wax and/or an ester wax helps provide effective releasability.

Examples of the hydrocarbon wax include the following: aliphatic hydrocarbon waxes, such as low-molecular-weight polyethylene, low-molecular-weight polypropylene, low-molecular-weight olefin copolymers, Fischer-Tropsch wax, and waxes obtained by oxidation or acid addition of these waxes.

The ester wax is not limited as long as it has at least one ester bond in one molecule, and may be a natural ester wax or a synthetic ester wax.

Examples of the ester wax include the following:
esters of a monohydric alcohol and a monocarboxylic acid, such as behenyl behenate, stearyl stearate, and palmityl palmitate;
esters of a dicarboxylic acid and a monoalcohol, such as dibehenyl sebacate;
esters of a dihydric alcohol and a monocarboxylic acid, such as ethylene glycol distearate and hexanediol dibehenate;
esters of a trihydric alcohol and a monocarboxylic acid, such as glyceryl tribehenate;
esters of a tetrahydric alcohol and a monocarboxylic acid, such as pentaerythritol tetrastearate and pentaerythritol tetrapalmitate;
esters of a hexahydric alcohol and a monocarboxylic acid, such as dipentaerythritol hexastearate, dipentaerythritol hexapalmitate, and dipentaerythritol hexabehenate;
esters of a polyfunctional alcohol and a monocarboxylic acid, such as polyglyceryl behenate; and
natural ester waxes such as carnauba wax and rice wax.

Of these, an ester wax that is an ester of an alcohol with a valence of 4 or more and 8 or less and an aliphatic monocarboxylic acid, or an ester wax that is an ester of a carboxylic acid with a valence of 4 or more and 8 or less and an aliphatic monoalcohol is preferred. The presence of such a wax reduces the compatibility with the crystalline vinyl resin at the time of fixing, so that the releasability at the time of low-temperature fixation tends to improve, leading to higher low-temperature fixability.

Esters of a tetrahydric alcohol and a monocarboxylic acid, such as pentaerythritol tetrastearate, pentaerythritol tetrapalmitate, and pentaerythritol tetrabehenate; esters of a hexahydric alcohol and a monocarboxylic acid, such as dipentaerythritol hexastearate, dipentaerythritol hexapalmitate, and dipentaerythritol hexabehenate; and esters of an octahydric alcohol and a monocarboxylic acid, such as tripentaerythritol octastearate, tripentaerythritol octapalmitate, and tripentaerythritol octabehenate, are more preferred.

The content of the wax in the toner particles is preferably 1.0 mass % or more and 30.0 mass % or less, more preferably 2.0 mass % or more and 25.0 mass % or less. When the content of the wax in the toner particles is in this range, the releasability at the time of fixing is more readily provided.

The melting point of the wax is preferably 60° C. or higher and 120° C. or lower. When the melting point of the wax is in this range, the wax readily melts at the time of fixing to bleed out on the surface of the toner particles, so that the wax readily volatilizes. The melting point of the wax is more preferably 70° C. or higher and 100° C. or lower.

The toner particles may contain a coloring agent. Examples of the coloring agent include known organic pigments, organic dyes, inorganic pigments, carbon black as a black coloring agent, and magnetic particles. In addition, coloring agents conventionally used in toners may be used.

Examples of yellow coloring agents include the following: condensed azo compounds, isoindolinone compounds, anthraquinone compounds, azo-metal complexes, methine compounds, and allylamide compounds. Of these, C.I. Pigment Yellow 12, 13, 14, 15, 17, 62, 74, 83, 93, 94, 95, 109, 110, 111, 128, 129, 147, 155, 168, and 180 are suitable for use.

Examples of magenta coloring agents include the following: condensed azo compounds, diketopyrrolopyrrole compounds, anthraquinone compounds, quinacridone compounds, basic dye lake compounds, naphthol compounds, benzimidazolone compounds, thioindigo compounds, and perylene compounds. Of these, C.I. Pigment Red 2, 3, 5, 6, 7, 23, 48:2, 48:3, 48:4, 57:1, 81:1, 122, 144, 146, 166, 169, 177, 184, 185, 202, 206, 220, 221, and 254 are suitable for use.

Examples of cyan coloring agents include the following: copper phthalocyanine compounds and derivatives thereof, anthraquinone compounds, and basic dye lake compounds. Of these, C.I. Pigment Blue 1, 7, 15, 15:1, 15:2, 15:3, 15:4, 60, 62, and 66 are suitable for use.

The coloring agent is selected in view of hue angle, color saturation, lightness value, light fastness, OHP transparency, and dispersibility in toner.

The content of the coloring agent in the toner particles is preferably 1.0 parts by mass or more 20.0 parts by mass or less relative to 100.0 parts by mass of the toner particles. When magnetic particles are used as the coloring agent, the content thereof is preferably 40.0 parts by mass or more and 150.0 parts by mass or less relative to 100.0 parts by mass of the toner particles.

The toner particles may contain a charge control agent. Alternatively, a charge control agent may be externally added to the toner particles. The use of a charge control agent stabilizes charge characteristics and enables control of an optimum triboelectric charging amount according to the development system.

The charge control agent may be a charge control agent that has a high charging speed and can stably maintain a constant charging amount.

Examples of charge control agents that control the toner to be negatively charged include the following. Organometallic compounds and chelate compounds are effective, and examples include monoazo metal compounds, acetylacetone metal compounds, and aromatic oxycarboxylic acid-based, aromatic dicarboxylic acid-based, oxycarboxylic acid-based, and dicarboxylic acid-based metal compounds.

Examples of charge control agents that control the toner to be positively charged include the following: nigrosine, quaternary ammonium salts, metal salts of higher fatty acids, diorganotin borates, guanidine compounds, and imidazole compounds.

The content of the charge control agent in the toner particles is preferably 0.01 parts by mass or more and 20.0 parts by mass or less, more preferably 0.5 parts by mass or more and 10.0 parts by mass or less, relative to 100.0 parts by mass of the toner particles.

The toner particles may be used as the toner without any treatment or with an external additive or the like added and attached to the surface of the toner particles as needed.

Examples of the external additive include fine inorganic particles selected from the group consisting of fine silica particles, fine alumina particles, and fine titania particles, and composite oxides thereof. Examples of the composite oxides include fine silica aluminum particles and fine strontium titanate particles.

The content of the external additive is preferably 0.01 parts by mass or more and 8.0 parts by mass or less, more preferably 0.1 parts by mass or more and 4.0 parts by mass or less, relative to 100 parts by mass of the toner particles.

The toner particles according to the present disclosure can be produced by a method such as a suspension polymerization method, an emulsion aggregation method, a dissolution suspension method, or a pulverization method, and may be produced by the suspension polymerization method.

The suspension polymerization method will be described in detail.

For example, a crystalline vinyl resin synthesized in advance is added to a mixture of polymerizable monomers. Other materials such as a coloring agent, a wax, and a charge control agent are added as needed, and uniformly dissolved or dispersed to prepare a polymerizable monomer composition.

Thereafter, the polymerizable monomer composition is dispersed in an aqueous medium using a stirrer or the like to prepare suspended particles of the polymerizable monomer composition. Thereafter, the polymerizable monomer contained in the particles is polymerized using an initiator or the like to obtain toner particles. By utilizing hydrogen abstraction reaction at the time of this polymerization reaction, the polymerizable monomers are reacted in certain amounts with the crystalline vinyl resin polymerized in advance, so that the crystalline vinyl resin is easily controlled to have desired physical properties.

After completion of the polymerization, filtration, washing, and drying of the toner particles are performed, and an external additive is added as needed, whereby a toner can be obtained.

Examples of polymerization initiators include azo or diazo polymerization initiators such as 2,2′-azobis-(2,4-dimethylvaleronitrile), 2,2′-azobisisobutyronitrile, 1,1′-azobis(cyclohexane-1-carbonitrile), 2,2′-azobis-4-methoxy-2,4-dimethylvaleronitrile, and azobisisobutyronitrile; and peroxide polymerization initiators such as benzoyl peroxide, t-butylperoxy 2-ethylhexanoate, t-butylperoxy pivalate, t-butylperoxy isobutyrate, t-butylperoxy octoate, t-butylperoxy neodecanoate, methyl ethyl ketone peroxide, diisopropylperoxy carbonate, cumene hydroperoxide, 2,4-dichlorobenzoyl peroxide, and lauroyl peroxide. Polymerization initiators that easily cause a hydrogen abstraction reaction are peroxide polymerization initiators, which are suitable for use. Of these, initiators such as t-butylperoxy 2-ethylhexanoate, t-butylperoxy pivalate, t-butylperoxy isobutyrate, t-butylperoxy octoate, and t-butylperoxy neodecanoate are more suitable for use.

The temperature during the polymerization reaction may be 15° C. to 25° C. higher than the 10-hour half-life temperature of an initiator. Within this range, the hydrogen abstraction reaction tends to occur moderately, so that the crystalline vinyl resin is easily controlled to have desired physical properties.

A chain transfer agent and/or a polymerization inhibitor may also be used.

The aqueous medium may contain an inorganic and/or organic dispersion stabilizer.

Examples of the inorganic dispersion stabilizer include phosphates such as hydroxy apatite, tribasic calcium phosphate, dibasic calcium phosphate, magnesium phosphate, aluminum phosphate, and zinc phosphate; carbonates such as calcium carbonate and magnesium carbonate; metal hydroxides such as calcium hydroxide, magnesium hydroxide, and aluminum hydroxide; sulfates such as calcium sulfate and barium sulfate; calcium metasilicate; bentonite; silica; and alumina.

Examples of the organic dispersion stabilizer include polyvinyl alcohol, gelatin, methyl cellulose, methylhydroxypropyl cellulose, ethyl cellulose, carboxymethyl cellulose sodium salt, polyacrylic acid and salts thereof, and starch.

When an inorganic compound is used as the dispersion stabilizer, a commercially available product may be directly used, or to obtain finer particles, the inorganic compound may be produced in the aqueous medium and used.

For example, in the case of calcium phosphate such as hydroxy apatite or tribasic calcium phosphate, an aqueous phosphate solution and an aqueous calcium salt solution may be mixed under vigorous stirring.

The aqueous medium may contain a surfactant. Examples of the surfactant include anionic surfactants such as sodium dodecylbenzene sulfate and sodium oleate; cationic surfactants; amphoteric surfactants; and nonionic surfactants.

Methods for calculating and measuring various physical properties of a toner and toner materials will be described below.

Separation of Toner Particles from Toner

Toner particles and an external additive are separated from each other in the following manner, and the obtained toner particles can be used for analyses.

Sucrose (manufactured by Kishida Chemical Co., Ltd.) in an amount of 160 g is added to 100 mL of deionized water and dissolved in a hot water bath to prepare an aqueous sucrose solution. The aqueous sucrose solution in an amount of 31 g and 6 mL of Contaminon N (a 10 mass % aqueous solution of a neutral detergent for cleaning precise measuring equipment, the solution being composed of a nonionic surfactant, an anionic surfactant, and an organic builder and having a pH of 7, manufactured by FUJIFILM Wako Pure Chemical Corporation) are put into a centrifuge tube to prepare a dispersion liquid. To this dispersion liquid, 1 g of a toner is added, and clumps of the toner are broken up with a spatula or the like.

The centrifuge tube is set in a “KM Shaker” (model: V.SX) manufactured by Iwaki Industry Co., Ltd. and shaken for 20 minutes under the condition of 350 reciprocating cycles per minute. After the shaking, the solution is transferred to a glass tube (50 mL) for a swing rotor and centrifuged at 3,500 rpm for 30 minutes using a centrifugal machine.

In the glass tube that has been subjected to centrifugation, toner particles are present in the uppermost layer, and external additives such as fine silica particles are present on the lower-layer aqueous solution side. The toner particles in the upper layer are collected, filtered, and washed with 2 L of flowing deionized water heated to 40° C., and the washed toner particles are taken out.

Separation of Component A, Component B, and Chloroform Insoluble Matter in Resin from Toner Particles and Measurement of Percentage Content

The toner particles in an amount of 1.5 g are accurately weighed (W1 [g]) and placed in an extraction thimble (trade name: No. 86R, 28×100 mm in size, manufactured by Advantec Toyo Kaisha, Ltd.) accurately weighed in advance, and the extraction thimble is set in a Soxhlet extractor. Using 200 mL of chloroform as a solvent, extraction is performed for 18 hours at a reflux rate such that one solvent extraction cycle ends in about 5 minutes.

After completion of the extraction, the extraction thimble is taken out and dried in air, and then dried under vacuum at 40° C. for 8 hours. The mass of the extraction thimble including the extraction residue is weighed, and the mass of the extraction thimble is subtracted to thereby calculate the mass (W3 [g]) of the extraction residue (chloroform insoluble matter). When chloroform soluble matter (W2 [g]) is recovered, it can be recovered by sufficiently distilling off chloroform from the soluble matter in chloroform with an evaporator.

Next, the content (W4 [g]) of a resin component in the chloroform insoluble matter is determined by the following procedure.

In a 30 mL magnetic crucible weighed in advance, 2 g of the chloroform insoluble matter of the toner particles is accurately weighed (Wa′ [g]).

The magnetic crucible is placed in an electric furnace, heated at about 900° C. for 3 hours, and allowed to cool in the electric furnace. At normal temperature, the magnetic crucible is allowed to cool in a desiccator for 1 hour or more. The mass of the crucible including incineration residual ash is weighed, and the mass of the crucible is subtracted to thereby calculate the mass (Wb′ [g]) of the incineration residual ash.

The mass (W5 [g]) of the incineration residual ash in the specimen W1 [g] is calculated by the following formula.

$$W 5 = W 1 \times ( {Wb}^{′} / {Wa}^{′} )$$

Next, the mass (W4 [g]) of a resin C, which is a resin component excluding the incineration residual ash in the chloroform insoluble matter of the toner particles, is calculated by the following formula.

$$W 4 = W 1 - W 5$$

When the toner particles contain a wax, it is necessary to separate the resin and the wax from each other.

The separation of the resin and the wax is performed by recycling HPLC with a component having a molecular weight of 2,000 or less regarded as the wax. The measurement method is described below. First, the chloroform soluble matter is separated by the above-described method and dissolved in chloroform. The resulting solution is then filtered through a solvent-resistant membrane filter “Maishori Disc” (manufactured by Tosoh Corporation) having a pore size of 0.2 m to obtain a sample solution. The sample solution is adjusted such that the concentration of components soluble in chloroform is 1.0 mass %. Using this sample solution, the measurement is performed under the following conditions.
Apparatus: LC-Sakura NEXT (manufactured by Japan Analytical Industry Co., Ltd.)
Column: JAIGEL 2H, 4H (manufactured by Japan Analytical Industry Co., Ltd.)
Eluent: chloroform
Flow rate: 10.0 mL/min
Oven temperature: 40.0° C.
Specimen injection volume: 1.0 mL

In calculating the molecular weight of the specimen, a molecular weight calibration curve prepared using a standard polystyrene resin (e.g., trade name “TSK Standard Polystyrene F-850, F-450, F-288, F-128, F-80, F-40, F-20, F-10, F-4, F-2, F-1, A-5000, A-2500, A-1000, or A-500”, manufactured by Tosoh Corporation) is used.

On the basis of the molecular weight curve thus obtained, the component having a molecular weight of 2,000 or less is repeatedly recovered to separate a resin component (W) and a wax component (Wd) in the chloroform soluble matter of the toner. The content (W6 [g]) of the resin component in the chloroform soluble matter (W2) in the toner particles W1 [g] is then calculated by the following formula.

$$W 2 = W 1 - W 3 \\ W 6 = W 2 \times ( Wc / ( W + Wd ) ) \times W 1 \times 0.01$$

In separating a component A and a component B from the toner particles, the above-described resin component (W) in the chloroform soluble matter of the toner particles is used as a specimen. The specimen is adjusted with chloroform so as to have a sample concentration of 1.0 mass %. This solution is filtered through a 0.45 m PTFE filter, and the filter residue is subjected to measurement. Gradient polymer LC measurement conditions are shown below.
Apparatus: UlTIMATE 3000 (manufactured by Thermo Fisher Scientific)
Mobile phase: A, chloroform (HPLC); B, acetonitrile (HPLC)
Gradient: 2 min (A/B=0/100)→25 min (A/B=100/0) (the gradient of the change in mobile phase is controlled to be linear)
Flow rate: 1.0 mL/min
Injection: 1.0 mass %×20 μL
Column: Tosoh TSKgel ODS (4.6 mm in diameter×150 mm in length×5 m)
Column temperature: 40° C.
Detector: Corona charged particle detector (Corona-CAD) (manufactured by Thermo Fisher Scientific)

For a time-signal intensity (μA) graph obtained by the measurement, time is converted to chloroform percentage (vol %). Thereafter, from local maximal values observed, a local maximal value with a highest signal intensity and a local maximal value with a second highest signal intensity are selected. Of these two local maximal values, a local maximal value at which the chloroform percentage in the mobile phase is smaller is determined as PA, and a local maximal value at which the chloroform percentage in the mobile phase is larger is determined as PB. Furthermore, a local minimum value with a lowest intensity present between PA and PB is determined as BAB, and a chloroform percentage at BAB is determined as VAB (vol %).

Thereafter, the above measurement is repeatedly performed 50 times. An area where the proportion of the mobile phase is 20.0 vol % or more and less than VAB vol % is recovered as an acetonitrile/chloroform solution of the component A, and an area where the proportion of the mobile phase is VAB vol % or more and 95.0% or less is recovered as an acetonitrile/chloroform solution of the component B. Acetonitrile/chloroform is sufficiently distilled off with an evaporator to thereby collect the component A (We [g]) and the component B (Wf [g]).

The content (W7 [g]) of the component A and the content (W8 [g]) of the component B in the chloroform soluble matter (W2) of the toner particles W1 [g] are calculated by the following formulas.

$$W 7 = W 6 \times We / ( 1.484 \times 1. \times 0.01 \times 20 \times 0.001 \times 50 ) \\ W 8 = W 7 \times Wf / ( 1.484 \times 1. \times 0.01 \times 20 \times 0.001 \times 50 )$$

The percentage content (W9 [mass %]) of the component A, the percentage content (W10 [mass %]) of the component B, and the percentage content (W11 [mass %]) of the chloroform insoluble matter of the resin component based on the mass of the resin component in the present disclosure are calculated by the following formulas.

$$W 9 = W 7 / ( W 6 + W 4 ) \\ W 10 = W 8 / ( W 6 + W 4 ) \\ W 11 = W 4 / ( W 6 + W 4 )$$

### Method of Measuring Percentage Contents of Unit (a) in Resin Component, Chloroform Soluble Matter W, and Component B

The measurement of the percentage contents of the unit (a) in the resin component, the chloroform soluble matter W, and the component B is performed by ¹H-NMR under the following conditions.
Measuring apparatus: FT NMR apparatus JNM-EX400 (manufactured by JEOL Ltd.)
Measurement frequency: 400 MHz
Pulse condition: 5.0 μs
Frequency range: 10,500 Hz
Number of scans: 64
Measurement temperature: 30° C.
Specimen: prepared in the following manner

A measurement specimen in an amount of 50 mg is placed in a sample tube having an inner diameter of 5 mm, deuterochloroform (CDCl₃) as a solvent is added, and the resulting mixture is dissolved in a constant-temperature bath at 40° C. to prepare a specimen.

The obtained ¹H-NMR chart is analyzed to identify the structures of units. Here, the measurement of the percentage content of the unit (a) in the component B is described as an example. From among peaks attributed to constituents of the unit (a) in the obtained ¹H-NMR chart, a peak independent of peaks attributed to constituents of other units is selected, and an integral value S1 of this peak is calculated. For each of the other units contained in the resin, the integral value is calculated in the same manner.

When the component B is constituted by the unit (a) and another unit, the percentage content of the unit (a) is determined in the following manner using the integral value S1 and an integral value S2 of the peak of the other unit. n1 and n2 each represent the number of hydrogen atoms in a constituent to which the peak of interest of each unit is attributed.

$$Percentage content ( mol \% ) of unit ( a ) = \{ ( S 1 / n 1 ) / ( ( S 1 / n 1 ) + ( S 2 / n 2 ) ) \} \times 100$$

Also when two or more other units are present, the percentage content of the unit (a) can be calculated in the same manner (using S3 . . . Sx and n3 . . . nx).

When a monomer containing no hydrogen atoms is used as a constituent other than vinyl groups, the measurement is performed in a single pulse mode using ¹³C-NMR, in which the nucleus to be measured is ¹³C, and the percentage content can be calculated in the same manner by ¹H-NMR. The percentage (mol %) of each unit calculated by the above method is multiplied by the molecular weight of each unit to convert the percentage content of each unit into a mass percentage.

### Measurement of Storage Elastic Moduli of Toner Particles and Component B at 100° C.

The storage elastic moduli are measured using an MCR302 (manufactured by Anton Paar GmbH). The method of measuring the storage elastic modulus of the toner particles at 100° C. will be described below.

The toner particles in an amount of 120 mg are weighed and molded at 20 kN for 1 minute using a tableting machine to obtain a disk-shaped specimen having a diameter of 8 mm.

The obtained specimen is set in a measuring tool under the following conditions.
Measuring tool name: Measuring plate PP08/SD: 8 mm, sandblasted
Setting conditions: 80° C., 0.1 N

Next, the viscoelasticity was measured under the following conditions.
Frequency: 1 Hz
Normal force: 100 mN
Applied strain: changed from 0.5% to 7.0% at 0.22%/min

While the temperature is raised from 70° C. to 130° C. at 2° C./min, the measurement is performed for 30 minutes. The sampling pitch at this time is 1 point/0.5 min.

In the measurement, the calculated storage elastic modulus (Pa) at 100° C. is determined as a storage elastic modulus G′(T) of the toner particles at 100° C. Likewise, the storage elastic modulus at 100° C. obtained when the component B is used as a sample is determined as a storage elastic modulus G′(B).

### Method of Determining Molecular Weight (Weight−Average Molecular Weight Mw) of Component B

The molecular weight (weight-average molecular weight Mw) of THF soluble matter of the component B is determined by gel permeation chromatography (GPC) in the following manner.

First, the component B is dissolved in tetrahydrofuran (THF) at room temperature over 24 hours. The resulting solution is filtered through a solvent-resistant membrane filter “Maishori Disc” (manufactured by Tosoh Corporation) having a pore size of 0.2 m to obtain a sample solution. The sample solution is adjusted such that the concentration of components soluble in THF is 0.8 mass %. Using this sample solution, the measurement is performed under the following conditions.
Apparatus: HLC8120 GPC (detector: RI) (manufactured by Tosoh Corporation)
Column: Shodex KF-801, 802, 803, 804, 805, 806, and 807, seven connected columns (manufactured by Resonac Holdings Corporation)
Eluent: tetrahydrofuran (THF)
Flow rate: 1.0 mL/min
Oven temperature: 40.0° C.
Specimen injection volume: 0.10 mL

In calculating the molecular weight (weight-average molecular weight Mw) of the specimen, a molecular weight calibration curve prepared using a standard polystyrene resin (e.g., trade name “TSK Standard Polystyrene F-850, F-450, F-288, F-128, F-80, F-40, F-20, F-10, F-4, F-2, F-1, A-5000, A-2500, A-1000, or A-500”, manufactured by Tosoh Corporation) is used.

### EXAMPLES

A more specific description will be given below with reference to Examples. In the following formulations, “parts” are “parts by mass” unless otherwise specified.

### Preparation of Resin A1

The following materials were added into an autoclave equipped with a decompression device, a water separation device, a nitrogen gas introduction device, a temperature measuring device, and a stirring device.

| | |
|---|---|
| Terephthalic acid | 25.3 parts |
| Propylene oxide (2 mol) adduct of bisphenol A | 74.7 parts |
| Potassium titanium oxalate (catalyst) | 0.02 parts |

Subsequently, the materials were allowed to react in a nitrogen atmosphere under normal pressure at 220° C. for 5 hours and under reduced pressure at 220° C. for 3 hours. After the temperature was lowered, the resultant was pulverized to obtain a resin A1. The resin A1 had a weight-average molecular weight (Mw) of 10,280.

### Preparation of Resin A2

An autoclave was charged with 50.0 parts of xylene and purged with nitrogen, and then the temperature was raised to 185° C. with stirring in a hermetically sealed state. To the autoclave, 79.0 parts of styrene, 17.0 parts of n-butyl acrylate, 3.1 parts of divinylbenzene, 0.9 parts of acrylic acid, and a mixed solution of 1.0 parts of di-tert-butyl peroxide and 20.0 parts of xylene were continuously added dropwise for 3 hours to effect polymerization while the temperature in the autoclave was controlled at 185° C. Furthermore, the temperature was held there for 1 hour to complete the polymerization, and the solvent was removed to obtain a resin A2. The resin A2 had a weight-average molecular weight (Mw) of 60,000.

### Preparation of Resin B1

A reaction vessel equipped with a reflux condenser, a stirrer, a thermometer, and a nitrogen inlet tube was charged with the following materials in a nitrogen atmosphere.

| | |
|---|---|
| Toluene | 100.0 parts |
| Monomer composition | 100.0 parts |

### (The Monomer Composition is a Mixture of the Following Monomers in the Following Proportion)

| | |
|---|---|
| Behenyl acrylate | 60.0 parts |
| Styrene | 20.0 parts |
| Methacrylonitrile | 10.0 parts |
| N-vinyl-2-pyrolidone | 10.0 parts |
| Polymerization initiator | t-butylperoxy pivalate (Perbutyl PV |
| | manufactured by NOF Corporation), |
| | 0.5 parts by mass |

While the above materials were stirred at 200 rpm in a reaction vessel, a polymerization reaction was performed for 12 hours at an elevated temperature of 70° C. to obtain a solution in which a polymer in the monomer composition was dissolved in toluene. Subsequently, the solution was cooled to 25° C. and then put into 1000.0 parts of methanol with stirring to precipitate methanol insoluble matter. The obtained methanol insoluble matter was separated by filtration, further washed with methanol, and then vacuum dried at 40° C. for 24 hours to obtain a resin B1. The physical properties of the resin B1 are shown in Table 1.

### Preparation of Resins B2 to B6

Crystalline resins B2 to B6 were prepared in the same manner as the resin B1 except that the amount of the monomer composition added was changed as shown in Table 1. The physical properties of the resins B2 to B6 are shown in Table 1.

TABLE 1

| | | | | | | | | | | Polymerization | |
|---|---|---|---|---|---|---|---|---|---|---|---|
| | Monomer (a) | | | Other monomer 1 | | Other monomer 2 | | Other monomer 3 | | initiator | |
| | | Carbon | Addition | | Addition | | Addition | | Addition | Addition | Molecular |
| Resin | | number | amount | | amount | | amount | | amount | amount | weight |
| B | Type | n | (parts) | Type | (parts) | Type | (parts) | Type | (parts) | (parts) | Mw |
| Resin | behenyl | 21 | 60.0 | styrene | 20.0 | acrylonitrile | 10.0 | N-vinyl-2- | 10.0 | 0.5 | 30200 |
| B1 | acrylate | | | | | | | pyrolidone | | | |
| Resin | behenyl | 21 | 60.0 | styrene | 20.0 | acrylonitrile | 20.0 | — | — | 0.5 | 29860 |
| B2 | acrylate | | | | | | | | | | |
| Resin | behenyl | 21 | 50.0 | styrene | 20.0 | acrylonitrile | 10.0 | N-vinyl-2- | 10.0 | 0.5 | 32450 |
| B3 | acrylate | | | | | | | pyrolidone | | | |
| | stearyl | 17 | 10.0 | | | | | | | | |
| | acrylate | | | | | | | | | | |
| Resin | behenyl | 21 | 80.0 | styrene | 10.0 | acrylonitrile | 5.0 | N-vinyl-2- | 5.0 | 0.5 | 31560 |
| B4 | acrylate | | | | | | | pyrolidone | | | |
| Resin | behenyl | 21 | 50.0 | styrene | 30.0 | acrylonitrile | 10.0 | N-vinyl-2- | 10.0 | 0.5 | 32130 |
| B5 | acrylate | | | | | | | pyrolidone | | | |
| Resin | behenyl | 21 | 60.0 | styrene | 27.5 | acrylonitrile | 10.0 | acrylic | 2.5 | 0.5 | 34000 |
| B6 | acrylate | | | | | | | acid | | | |

Polymerization initiator: t-butylperoxy pivalate (Perbutyl PV manufactured by NOF Corporation)

### Example 1

### Production of Toner by Suspension Polymerization Method

### Production of Toner Particles 1

A mixture of the following materials was prepared.

| | | |
|---|---|---|
| Styrene | 45.0 | parts |
| n-Butyl acrylate | 15.0 | parts |
| Pigment blue 15:3 (coloring agent) | 6.5 | parts |

The mixture was put in an attritor (manufactured by Nippon Coke & Engineering Co., Ltd.) and dispersed at 200 rpm for 2 hours using zirconia beads with a diameter of 5 mm to obtain a raw-material dispersion liquid.

Separately, 735.0 parts of deionized water and 16.0 parts of trisodium phosphate (dodecahydrate) were added to a vessel equipped with a high-speed stirring device, HOMO MIXER (manufactured by PRIMIX Corporation), and a thermometer and heated to 60° C. with stirring at 12,000 rpm. An aqueous calcium chloride solution in which 9.0 parts of calcium chloride (dihydrate) was dissolved in 65.0 parts of deionized water was put therein, and stirring was performed at 12,000 rpm for 30 minutes while the temperature was maintained at 60° C. To the mixture, 10% hydrochloric acid was added to adjust the pH to 6.0, whereby an aqueous medium in which a hydroxy apatite-containing inorganic dispersion stabilizer was dispersed in water was obtained.

Subsequently, the raw-material dispersion liquid was transferred to a vessel equipped with a stirring device and a thermometer and heated to 60° C. with stirring at 100 rpm. The following materials were added thereto.

| | | |
|---|---|---|
| Resin A1 | 4.0 | parts |
| Resin B1 | 35.0 | parts |
| DP18 (dipentaerythritol stearate wax; melting point, | 9.0 | parts |
| 79° C.; manufactured by The Nisshin OilliO Group, Ltd.) | | |
| HDDA (hexanediol diacrylate) | 0.1 | parts |

The mixture was stirred at 100 rpm for 30 minutes while the temperature was maintained at 60° C., and then further stirred for 1 minute with 8.0 parts of t-butylperoxy pivalate (Perbutyl PV manufactured by NOF Corporation) added as a polymerization initiator. Thereafter, the resulting mixture was put in the aqueous medium stirred at 12,000 rpm with the high-speed stirring device. While the temperature was maintained at 60° C., stirring was continued at 12,000 rpm for 20 minutes with the high-speed stirring device to obtain a granulated liquid.

The granulated liquid was transferred to a reaction vessel equipped with a reflux condenser, a stirrer, a thermometer, and a nitrogen inlet tube, and the temperature was raised to 76° C. with stirring at 150 rpm in a nitrogen atmosphere. While the temperature was maintained at 76° C., a polymerization reaction was performed at 150 rpm for 6 hours to obtain a toner-particle dispersion liquid.

The obtained toner-particle dispersion liquid was cooled to 45° C. with stirring at 150 rpm, and then heat treated for 5 hours while the temperature was maintained at 45° C. Thereafter, while the stirring was kept continued, dilute hydrochloric acid was added until pH 1.5 to dissolve the dispersion stabilizer. Solids were separated by filtration, thoroughly washed with deionized water, and then vacuum dried at 30° C. for 24 hours to obtain toner particles 1.

### Preparation of Toner 1

To 98.0 parts of the toner particles 1, 2.0 parts of fine silica particles (hydrophobized with hexamethyldisilazane; number-average primary particle diameter, 10 nm; BET specific surface area, 170 m²/g) as an external additive was added and mixed at 3,000 rpm for 15 minutes using a Henschel Mixer (manufactured by Nippon Coke & Engineering Co., Ltd.) to obtain a toner 1. Physical properties, etc. of the obtained toner 1 are shown in Table 3.

### Examples 2 to 23

Toner particles 2 to 23 were obtained in the same manner as in Example 1 except that the type and addition amount of the polymerizable monomers used, the addition amount of the polymerization initiator, the type and addition amount of the release agent, the other additives, the reaction temperature, and the reaction time were changed as shown in Table 2.

Furthermore, the same external addition as in Example 1 was performed to obtain toners 2 to 23. The physical properties of the toners are shown in Table 3.

### Comparative Examples 1 to 6

Comparative toner particles 1 to 6 were obtained in the same manner as in Example 1 except that the type and addition amount of the polymerizable monomers used, the addition amount of the polymerization initiator, the type and addition amount of the release agent, the other additives, the reaction temperature, and the reaction time were changed as shown in Table 2.

Furthermore, the same external addition as in Example 1 was performed to obtain comparative toners 1 to 6. The physical properties of the toners are shown in Table 3.

### Comparative Example 7

### Production of Comparative Toner Particles 7

A mixture of the following materials was prepared.

| | | |
|---|---|---|
| Methacrylonitrile | 30.0 | parts |
| Styrene | 13.0 | parts |
| Ethyl methacrylate | 7.0 | parts |
| Aluminum di-t-butyl salicylate | 1.0 | parts |
| Coloring agent, pigment blue 15:3 | 6.5 | parts |

The mixture was put in an attritor (manufactured by Nippon Coke & Engineering Co., Ltd.) and dispersed at 200 rpm for 2 hours using zirconia beads with a diameter of 5 mm to obtain a raw-material dispersion liquid. Separately, 735.0 parts of deionized water and 16.0 parts of trisodium phosphate (dodecahydrate) were added to a vessel equipped with a high-speed stirring device, HOMO MIXER (manufactured by PRIMIX Corporation), and a thermometer and heated to 60° C. with stirring at 12,000 rpm. An aqueous calcium chloride solution in which 9.0 parts of calcium chloride (dihydrate) was dissolved in 65.0 parts of deionized water was put therein, and stirring was performed at 12,000 rpm for 30 minutes while the temperature was maintained at 60° C. To the mixture, 10% hydrochloric acid was added to adjust the pH to 6.0, whereby an aqueous medium in which a hydroxy apatite-containing inorganic dispersion stabilizer was dispersed in water was obtained.

Subsequently, the raw-material dispersion liquid was transferred to a vessel equipped with a stirring device and a thermometer and heated to 60° C. with stirring at 100 rpm. The following materials were added thereto.

| | |
|---|---|
| Behenyl acrylate | 50.0 parts |
| DP18 | 10.0 parts |

The mixture was stirred at 100 rpm for 30 minutes while the temperature was maintained at 60° C. Thereafter, the resulting mixture was further stirred for 1 minute with 7.0 parts of t-butylperoxy pivalate (Perbutyl PV manufactured by NOF Corporation) and 1.0 parts of t-butylperoxy isobutyrate (L80 manufactured by ARKEMA Yoshitomi, Ltd.) added as polymerization initiators. Thereafter, the resulting mixture was put in the aqueous medium stirred at 12,000 rpm with the high-speed stirring device. While the temperature was maintained at 60° C., stirring was continued at 12,000 rpm for 20 minutes with the high-speed stirring device to obtain a granulated liquid.

The granulated liquid was transferred to a reaction vessel equipped with a reflux condenser, a stirrer, a thermometer, and a nitrogen inlet tube, and the temperature was raised to 70° C. with stirring at 150 rpm in a nitrogen atmosphere, where a first-stage polymerization reaction was performed at 150 rpm for 5 hours. Thereafter, the temperature was raised to 90° C., and a second-stage polymerization reaction was performed for 5 hours while the temperature was maintained at 90° C. to obtain a toner-particle dispersion liquid.

The obtained toner-particle dispersion liquid was cooled to 45° C. with stirring at 150 rpm, and then heat treated for 5 hours while the temperature was maintained at 45° C. Thereafter, while the stirring was kept continued, dilute hydrochloric acid was added until pH 1.5 to dissolve the dispersion stabilizer. Solids were separated by filtration, thoroughly washed with deionized water, and then vacuum dried at 30° C. for 24 hours to obtain comparative toner particles 7. Furthermore, the same external addition as in Example 1 was performed to obtain a comparative toner 7. The physical properties of the obtained comparative toner 7 are shown in Table 3.

### Comparative Example 8

### Production Example of Comparative Toner Particles 8

The following materials were mixed.

| | |
|---|---|
| Resin A2 | 40 parts |
| Resin B6 | 60 parts |

The mixture was fed to a twin-screw kneader (manufactured by Kurimoto, Ltd., S5KRC kneader) at 1 kg/h, and 4.0 parts of t-butylperoxyisopropyl monocarbonate was simultaneously fed as a radical reaction initiator at 0.1 kg/h. Kneading extrusion was performed at 160° C. for 5 minutes at 100 rpm to effect reaction. Furthermore, nitrogen was fed through a vent port, and mixing was performed while the organic solvent was removed. A kneaded product obtained by kneading was cooled to thereby obtain a comparative resin 8. A measurement using gel permeation chromatography (GPC) revealed that the resin A2 and the resin B6 were partially reacted to cause an increase in weight-average molecular weight. The content of the reacted resins in the comparative resin 8 was 5 mass %.

The following materials were mixed using a Henschel Mixer (FM-75 model, manufactured by Nippon Coke & Engineering Co., Ltd.) at a rotation speed of 20 s⁻¹ and a rotation time of 5 minutes.

| | | |
|---|---|---|
| Comparative resin 8 | 100 | parts |
| Hydrocarbon wax | 5.0 | parts |
| (Fischer-Tropsch wax: peak temperature of | | |
| DSC maximum endothermic peak, 90° C.) | | |
| C.I. pigment blue 15:3 | 6.5 | parts |

Thereafter, the mixture was kneaded with a twin-screw kneader (PCM-30 model, manufactured by Ikegai Corporation) set at 130° C. at a screw rotation speed 250 rpm and a discharge temperature of 130° C. The resulting kneaded product was cooled and coarsely pulverized to 1 mm or less with a hammer mill to obtain a pulverized product. The obtained pulverized product was finely pulverized with a mechanical pulverizer (T-250, manufactured by FREUND-TURBO CORPORATION).

Furthermore, classification was performed using a Faculty F-300 (manufactured by Hosokawa Micron Corporation) to obtain comparative toner particles 8 having a weight-average particle diameter of about 6.0 μm. The operating conditions were as follows: classification rotor rotation speed, 130 s⁻¹; dispersion rotor rotation speed, 120 s⁻¹.

The following materials were mixed using a Henschel Mixer FM-10C model (manufactured by Chemical Machinery Division of Nippon Coke & Engineering Co., Ltd.) at a rotation speed of 30 s⁻¹ and a rotation time of 10 minutes to obtain a comparative toner 8.

| | | |
|---|---|---|
| Comparative toner particles 8 | 100 | parts |
| Hydrophobized fine silica particles having a number- | 0.5 | parts |
| average primary particle diameter of 15 nm | | |
| Hydrophobized fine silica particles having a number- | 1.0 | parts |
| average primary particle diameter of 80 nm | | |

The physical properties of the obtained comparative toner 8 are shown in Table 3.

TABLE 2-1

| | | | Resin | | | | | | | | | |
|---|---|---|---|---|---|---|---|---|---|---|---|---|
| | | | | | Polymerizable | | Polymerizable | | Crosslinking | | | |
| | | | Resin B | | monomer 1 | | monomer 2 | | agent | | Resin A | |
| | | | | Addition | | Addition | | Addition | | Addition | | Addition |
| | Toner | Production | | amount | | amount | | amount | | amount | | amount |
| | No. | method | Type | (parts) | Type | (parts) | Type | (parts) | Type | (parts) | Type | (parts) |
| Example 1 | 1 | suspension | resin B1 | 40.0 | styrene | 45.0 | n-butyl | 15.0 | HDDA | 0.1 | resin A1 | 4.0 |
| | | polymerization | | | | | acrylate | | | | | |
| Example 2 | 2 | suspension | resin B1 | 35.0 | styrene | 48.8 | n-butyl | 16.3 | HDDA | 0.1 | resin A1 | 4.0 |
| | | polymerization | | | | | acrylate | | | | | |
| Example 3 | 3 | suspension | resin B1 | 25.0 | styrene | 58.3 | n-butyl | 18.8 | HDDA | 0.2 | resin A1 | 4.0 |
| | | polymerization | | | | | acrylate | | | | | |
| Example 4 | 4 | suspension | resin B1 | 53.0 | styrene | 35.3 | n-butyl | 11.8 | HDDA | 0.1 | resin A1 | 4.0 |
| | | polymerization | | | | | acrylate | | | | | |
| Example 5 | 5 | suspension | resin B1 | 50.0 | styrene | 30.0 | n-butyl | 10.0 | HDDA | 0.1 | resin A1 | 4.0 |
| | | polymerization | | | | | acrylate | | | | | |
| Example 6 | 6 | suspension | resin B1 | 25.0 | styrene | 56.3 | n-butyl | 18.8 | HDDA | 0.1 | resin A1 | 4.0 |
| | | polymerization | | | | | acrylate | | | | | |
| Example 7 | 7 | suspension | resin B1 | 60.0 | styrene | 30.0 | n-butyl | 10.0 | HDDA | 0.1 | resin A1 | 4.0 |
| | | polymerization | | | | | acrylate | | | | | |
| Example 8 | 8 | suspension | resin B1 | 40.0 | styrene | 45.0 | n-butyl | 15.0 | HDDA | 0.1 | resin A1 | 4.0 |
| | | polymerization | | | | | acrylate | | | | | |
| Example 9 | 9 | suspension | resin B1 | 25.0 | styrene | 56.3 | n-butyl | 18.8 | HDDA | 0.5 | resin A1 | 4.0 |
| | | polymerization | | | | | acrylate | | | | | |
| Example 10 | 10 | suspension | resin B1 | 40.0 | styrene | 45.0 | n-butyl | 16.0 | HDDA | 0.1 | resin A1 | 4.0 |
| | | polymerization | | | | | acrylate | | | | | |
| Example 11 | 11 | suspension | resin B1 | 40.0 | styrene | 45.0 | n-butyl | 15.0 | HDDA | 0.1 | resin A1 | 4.0 |
| | | polymerization | | | | | acrylate | | | | | |
| Exemple 12 | 12 | suspension | resin B1 | 40.0 | styrene | 45.0 | n-butyl | 15.0 | HDDA | 0.1 | resin A1 | 4.0 |
| | | polymerization | | | | | acrylate | | | | | |
| Example 13 | 13 | suspension | resin B1 | 40.0 | styrene | 45.0 | n-butyl | 15.0 | HDDA | 0.1 | resin A1 | 4.0 |
| | | polymerization | | | | | acrylate | | | | | |
| Exemple 14 | 14 | suspension | resin B1 | 40.0 | styrene | 45.0 | n-butyl | 15.0 | HDDA | 0.1 | resin A1 | 4.0 |
| | | polymerization | | | | | acrylate | | | | | |
| Example 15 | 15 | suspension | resin B1 | 40.0 | styrene | 45.0 | n-butyl | 15.0 | HDDA | 1.0 | resin A1 | 4.0 |
| | | polymerization | | | | | acrylate | | | | | |
| Example 16 | 16 | suspension | resin B1 | 40.0 | styrene | 45.0 | n-butyl | 16.0 | HDDA | 1.3 | resin A1 | 4.0 |
| | | polymerization | | | | | acrylate | | | | | |
| Exemple 17 | 17 | suspension | resin B1 | 40.0 | styrene | 45.0 | n-butyl | 15.0 | HDDA | 0.1 | resin A1 | 4.0 |
| | | polymerization | | | | | acrylate | | | | | |
| Exemple 18 | 18 | suspension | resin B1 | 40.0 | styrene | 45.0 | n-butyl | 15.0 | HDDA | 0.1 | resin A1 | 4.0 |
| | | polymerization | | | | | acrylate | | | | | |
| Example 19 | 19 | suspension | resin B1 | 60.0 | styrene | 30.0 | n-butyl | 10.0 | HDDA | 0.1 | — | — |
| | | polymerization | | | | | acrylate | | | | | |
| Exemple 20 | 20 | suspension | resin B2 | 40.0 | styrene | 45.0 | n-butyl | 15.0 | HDDA | 0.1 | resin A1 | 4.0 |
| | | polymerization | | | | | acrylate | | | | | |
| Example 21 | 21 | suspension | resin B3 | 40.0 | styrene | 45.0 | n-butyl | 15.0 | HDDA | 0.1 | resin A1 | 4.0 |
| | | polymerization | | | | | acrylate | | | | | |
| Exemple 22 | 22 | suspension | resin B4 | 30.0 | styrene | 52.5 | n-butyl | 17.5 | HDDA | 0.1 | resin A1 | 4.0 |
| | | polymerization | | | | | acrylate | | | | | |
| Example 23 | 23 | suspension | resin B5 | 50.0 | styrene | 37.5 | n-butyl | 12.6 | HDDA | 0.1 | resin A1 | 4.0 |
| | | polymerization | | | | | acrylate | | | | | |
| Comparative | comparative | suspension | resin B1 | 22.0 | styrene | 58.5 | n-butyl | 19.5 | HDDA | 0.2 | resin A1 | 4.0 |
| Example 1 | 1 | polymerization | | | | | acrylate | | | | | |
| Comparative | comparative | suspension | resin B1 | 55.0 | styrene | 26.3 | n-butyl | 8.8 | HDDA | 0.1 | resin A1 | 4.0 |
| Example 2 | 2 | polymerization | | | | | acrylate | | | | | |
| Comparative | comparative | suspension | resin B1 | 22.0 | styrene | 58.5 | n-butyl | 19.5 | HDDA | 0.1 | resin A1 | 4.0 |
| Example 3 | 3 | polymerization | | | | | acrylate | | | | | |
| Comparative | comparative | suspension | resin B1 | 70.0 | styrene | 22.5 | n-butyl | 7.5 | HDDA | 0.1 | resin A1 | 4.0 |
| Example 4 | 4 | polymerization | | | | | acrylate | | | | | |
| Comparative | comparative | suspension | resin B1 | 40.0 | styrene | 45.0 | n-butyl | 15.0 | HDDA | 0.1 | resin A1 | 4.0 |
| Example 5 | 5 | polymerization | | | | | acrylate | | | | | |
| Comperative | comparative | suspension | resin B1 | 40.0 | styrene | 45.0 | n-butyl | 15.0 | HDDA | 0.1 | resin A1 | 4.0 |
| Example 6 | 6 | polymerization | | | | | acrylate | | | | | |

TABLE 2-2

| | | Other additive | Polymerization | | | | |
|---|---|---|---|---|---|---|---|
| | | Aluminum | initiator | Release agent | | | |
| | | di-t-butyl salicylate | Addition | | Addition | Reaction | |
| | Toner | addition | amount | | amount | Temperature | Time |
| | No. | amount (parts) | (parts) | Type | (parts) | (° C.) | (h) |
| Example 1 | 1 | — | 8.0 | dipentaerythritol stearate wax | 9.0 | 76.0 | 6.0 |
| Example 2 | 2 | — | 9.0 | dipentaerythritol stearate wax | 9.0 | 76.0 | 6.0 |
| Example 3 | 3 | — | 10.0 | dipentaerythritol stearate wax | 9.0 | 76.0 | 6.0 |
| Example 4 | 4 | — | 8.0 | dipentaerythritol stearate wax | 9.0 | 76.0 | 6.0 |
| Example 5 | 5 | — | 8.0 | dipentaerythritol stearate wax | 9.0 | 76.0 | 6.0 |
| Example 6 | 6 | — | 10.0 | dipentaerythritol stearate wax | 9.0 | 77.0 | 6.0 |
| Example 7 | 7 | — | 7.0 | dipentaerythritol stearate wax | 9.0 | 76.0 | 6.0 |
| Example 8 | 8 | — | 8.0 | dipentaeryihritol steerate wax | 9.0 | 74.0 | 6.0 |
| Example 9 | 9 | — | 13.0 | dipentaerythritol stearate wax | 9.0 | 77.0 | 6.0 |
| Example 10 | 10 | — | 6.0 | dipentaerythritol stearate wax | 9.0 | 74.0 | 6.0 |
| Example 11 | 11 | — | 4.0 | dipentaerythritol stearate wax | 9.0 | 73.0 | 6.0 |
| Example 12 | 12 | — | 9.0 | dipentaerythritol stearate wax | 9.0 | 76.0 | 6.0 |
| Example 13 | 13 | — | 9.5 | dipentaerythritol stearate wax | 9.0 | 76.0 | 6.0 |
| Example 14 | 14 | — | 8.0 | dipentaerythritol stearate wax | 9.0 | 76.0 | 6.0 |
| Example 15 | 15 | — | 8.0 | dipentaerythritol stearate wax | 9.0 | 76.0 | 6.0 |
| Examale 16 | 16 | — | 8.0 | dipentaerythritol stearate wax | 9.0 | 76.0 | 6.0 |
| Example 17 | 17 | — | 8.0 | pentaerythritol stearate wax | 9.0 | 76.0 | 6.0 |
| Example 18 | 18 | — | 8.0 | paraffin wax (HNP51) | 9.0 | 76.0 | 6.0 |
| Examale 19 | 19 | 0.5 | 8.0 | dipentaerythritol stearate wax | 9.0 | 76.0 | 6.0 |
| Example 20 | 20 | — | 8.0 | dipentaerythritol stearate wax | 9.0 | 76.0 | 6.0 |
| Example 21 | 21 | — | 8.0 | dipentaeryihritol stearate wax | 9.0 | 76.0 | 6.0 |
| Example 22 | 22 | — | 8.5 | dipentaerythritol stearate wax | 9.0 | 76.0 | 6.0 |
| Example 23 | 23 | — | 6.0 | dipentaeryihrilot stearate wax | 9.0 | 76.0 | 6.0 |
| Comparative | comparative 1 | — | 10.0 | dipentaerythritol stearate wax | 9.0 | 76.0 | 6.0 |
| Example 1 | | | | | | | |
| Comparative | comparative 2 | — | 8.0 | dipentaerythritol stearate wax | 9.0 | 76.0 | 6.0 |
| Example 2 | | | | | | | |
| Comparative | comparative 3 | — | 12.0 | dipentaerythritol stearate wax | 9.0 | 77.0 | 6.0 |
| Example 3 | | | | | | | |
| Comparative | comparative 4 | — | 8.0 | dipentaerythritol stearate wax | 9.0 | 74.0 | 6.0 |
| Example 4 | | | | | | | |
| Comparative | comparative 5 | — | 4.0 | dipentaerythritol stearate wax | 9.0 | 72.0 | 6.0 |
| Example 5 | | | | | | | |
| Comparative | comparative 6 | — | 10.5 | dipentaerythritol stearate wax | 9.0 | 76.0 | 6.0 |
| Example 8 | | | | | | | |

Polymerization initiator: t-butylperoxy pivalate (Perbutyl PV manufactured by NOF Corporation), 10-hour half-life temperature (58° C.)

TABLE 3-1

| | | Unit (a) content | Component B | | | |
|---|---|---|---|---|---|---|
| | | in resin | content in resin | | | G′(T)- |
| | Toner | component | component | | G′(T) | G′(B) |
| | No. | (mass %) | (mass %) | WB/WC | (Pa) | (Pa) |
| Example 1 | 1 | 26.6 | 65.5 | 0.97 | 10200 | 3350 |
| Example 2 | 2 | 21.6 | 52.0 | 0.97 | 48400 | 3040 |
| Example 3 | 3 | 15.4 | 42.0 | 0.98 | 86900 | 3980 |
| Example 4 | 4 | 33.4 | 72.0 | 0.95 | 6970 | 3500 |
| Example 5 | 5 | 37.9 | 78.0 | 0.92 | 5340 | 3590 |
| Example 6 | 6 | 15.4 | 64.3 | 0.98 | 87510 | 4030 |
| Example 7 | 7 | 36.8 | 63.4 | 0.90 | 5390 | 3520 |
| Example 8 | 8 | 25.8 | 44.5 | 0.97 | 12400 | 3620 |
| Example 9 | 9 | 15.4 | 76.0 | 0.97 | 86780 | 3540 |
| Example 10 | 10 | 25.3 | 64.5 | 0.91 | 11500 | 4890 |
| Example 11 | 11 | 25.3 | 65.8 | 0.91 | 10150 | 5890 |
| Example 12 | 12 | 25.3 | 68.9 | 0.91 | 11500 | 2810 |
| Example 13 | 13 | 25.3 | 69.7 | 0.91 | 12400 | 2120 |
| Example 14 | 14 | 24.4 | 65.5 | 0.97 | 9180 | 3400 |
| Example 15 | 15 | 30.2 | 64.5 | 0.96 | 48900 | 3010 |
| Example 16 | 16 | 32.6 | 62.2 | 0.96 | 87840 | 3880 |
| Example 17 | 17 | 26.6 | 65.5 | 0.94 | 11280 | 3900 |
| Example 18 | 18 | 26.6 | 65.5 | 0.92 | 10640 | 3700 |
| Example 19 | 19 | 27.9 | 62.8 | 0.97 | 9950 | 3100 |
| Example 20 | 20 | 26.3 | 65.5 | 0.97 | 11580 | 3730 |
| Example 21 | 21 | 26.5 | 63.8 | 0.98 | 9860 | 3280 |
| Example 22 | 22 | 26.6 | 64.8 | 0.94 | 9480 | 3700 |
| Example 23 | 23 | 27.7 | 66.8 | 0.94 | 9480 | 3700 |
| Comparative Example 1 | comparative 1 | 13.9 | 38.7 | 0.98 | 96800 | 3350 |
| Comparative Example 2 | comparative 2 | 41.1 | 83.1 | 0.91 | 5280 | 3640 |
| Comparative Example 3 | comparative 3 | 13.9 | 64.5 | 0.98 | 105310 | 3730 |
| Comparative Example 4 | comparative 4 | 42.9 | 63.4 | 0.90 | 4620 | 3810 |
| Comparative Example 5 | comparative 5 | 25.1 | 64.8 | 0.91 | 10150 | 6750 |
| Comparative Example 6 | comparative 6 | 25.3 | 70.5 | 0.91 | 12400 | 1720 |
| Comparative Example 7 | comparative 7 | 48.1 | 100 | 1.00 | 5480 | 0 |
| Comparative Example 8 | comparative 8 | 33.6 | 65.0 | 0.97 | 8680 | 7840 |

TABLE 3-2

| | | | | | Chloroform |
|---|---|---|---|---|---|
| | | | | Component | insoluble |
| | | Unit (a) | | A content | matter content |
| | | content in | Mw of | in resin | in resin |
| | | component B | component | component | component |
| | Toner No. | (mass %) | B | (mass %) | (mass %) |
| Example 1 | 1 | 39.4 | 97500 | 27.5 | 7.0 |
| Example 2 | 2 | 40.3 | 187500 | 44.5 | 3.5 |
| Example 3 | 3 | 36.0 | 212500 | 54.5 | 3.5 |
| Example 4 | 4 | 44.1 | 65700 | 23.5 | 4.5 |
| Example 5 | 5 | 44.6 | 41580 | 17.5 | 4.5 |
| Example 6 | 6 | 23.5 | 108910 | 32.2 | 3.5 |
| Example 7 | 7 | 52.2 | 78240 | 33.5 | 3.1 |
| Example 8 | 8 | 56.2 | 89870 | 50.0 | 5.5 |
| Example 9 | 9 | 19.6 | 79860 | 20.5 | 3.5 |
| Example 10 | 10 | 35.7 | 49860 | 30.9 | 4.6 |
| Example 11 | 11 | 35.0 | 29900 | 29.6 | 4.6 |
| Example 12 | 12 | 33.4 | 128900 | 26.5 | 4.6 |
| Example 13 | 13 | 33.0 | 137800 | 25.7 | 4.6 |
| Example 14 | 14 | 36.1 | 97500 | 31.7 | 2.8 |
| Example 15 | 15 | 45.0 | 189070 | 22.7 | 12.8 |
| Example 16 | 16 | 50.3 | 215800 | 22.0 | 15.8 |
| Example 17 | 17 | 38.2 | 97500 | 27.5 | 7.0 |
| Example 18 | 18 | 37.4 | 97500 | 27.5 | 7.0 |
| Example 19 | 19 | 43.1 | 97300 | 30.2 | 7.0 |
| Example 20 | 20 | 39.0 | 89850 | 28.0 | 6.5 |
| Example 21 | 21 | 40.7 | 92980 | 29.4 | 6.8 |
| Example 22 | 22 | 38.6 | 99480 | 28.2 | 7.0 |
| Example 23 | 23 | 39.0 | 91800 | 26.2 | 7.0 |
| Comparative | comparative 1 | 35.1 | 221500 | 56.8 | 4.5 |
| Example 1 | | | | | |
| Comparative | comparative 2 | 45.0 | 39800 | 12.3 | 4.6 |
| Example 2 | | | | | |
| Comparative | comparative 3 | 21.1 | 125400 | 30.9 | 4.6 |
| Example 3 | | | | | |
| Comparative | comparative 4 | 60.9 | 78240 | 33.5 | 3.1 |
| Example 4 | | | | | |
| Comparative | comparative 5 | 35.2 | 24800 | 31.0 | 4.2 |
| Example 5 | | | | | |
| Comparative | comparative 6 | 32.6 | 159800 | 24.9 | 4.6 |
| Example 6 | | | | | |
| Comparative | comparative 7 | 48.1 | 88000 | 0.0 | 0.0 |
| Example 7 | | | | | |
| Comparative | comparative 8 | 50.2 | 42800 | 35.0 | 0.0 |
| Example 8 | | | | | |

### Method of Evaluating Toner

The toners of Examples 1 to 23 and Comparative Examples 1 to 8 were each subjected to the following evaluations.

### <1> Low-Temperature Fixability

A process cartridge (a process cartridge for a laser beam printer (LBP-712Ci, manufactured by CANON KABUSHIKI KAISHA)) filled with a toner was left to stand at 25° C. and 40% RH for 48 hours. Using a modified machine based on a laser beam printer (LBP-712Ci) manufactured by CANON KABUSHIKI KAISHA modified so as to operate without a fixing unit, an unfixed image of an image pattern in which 10 mm×10 mm square images were evenly arranged with 9-point spacing over the entire recording paper was output. The toner bearing amount on the recording paper was set to 0.80 mg/cm², and the fixing start temperature was evaluated. As the recording paper, A4 paper (Plover Bond paper: 105 g/m², manufactured by Fox River Paper Company) was used.

As the fixing unit, an external fixing unit obtained by removing out the fixing unit of the laser beam printer (LBP-712Ci, manufactured by CANON KABUSHIKI KAISHA) and modifying the fixing unit so as to operate also outside the laser beam printer was used. While the fixing temperature of the external fixing unit was increased from 90° C. in increments of 5° C., fixing was performed at a process speed of 360 mm/s.

The fixed image was visually observed, and the low-temperature fixability was evaluated using the lowest temperature at which cold offset did not occur as a fixing start temperature. The evaluation results are shown in Table 4.

### <2> Adhesiveness to Paper (Abrasion Resistance of Fixed Image)

A fixed image was printed in the same manner as in the evaluation of <1> above. The fixing temperature was set to a temperature 5° C. high than a fixing start temperature. Soft thin paper (Dusper, manufactured by Ozu Corporation) was put on an image region of the obtained fixed image, and the image region was rubbed back and forth five times while a load of 4.9 kPa was applied from above the thin paper. Image densities before and after the rubbing were measured, and a rate of decrease ΔD (%) in image density was calculated by the following formula. ΔD (%) was used as an index of abrasion resistance.

$$Δ D ( \% ) = \{ ( image density before rubbing - image density after rubbing ) /$$

$$image density before rubbing \} \times 100$$

The image density was measured with a Color reflection densitometer (X-Rite 404A, manufactured by X-Rite Inc.). The evaluation results are shown in Table 4.

### <3> Hot-Offset Resistance

The highest temperature at which hot offset was not observed under the same conditions as in the evaluation of <1> above was determined as the highest fixing temperature, and a difference between the highest fixing temperature and the lowest fixing temperature was determined as a fixable region. The evaluation results are shown in Table 4.

### <4> Evaluation of Gloss

The fixed image at the fixing start temperature in the evaluation of <1> above was used. A gloss value was measured using a Handy type Gloss Meter PG-1 (manufactured by Nippon Denshoku Industries Co., Ltd.). Under the measurement conditions where the light emission angle and the light reception angle were each set to 75°, all the image patterns in which images were arranged with 9-point spacing were measured, and their average value was evaluated. The evaluation results are shown in Table 4. In the table, C.O. denotes cold offset, and H.O. denotes hot offset.

TABLE 4

| | | Low-temperature | Adhesiveness | | |
|---|---|---|---|---|---|
| | | fixability | to paper | | |
| | | Temperature at which | Rate of decrease in | H.O. resistance | Plain |
| | | C.O. does not occur | density by rubbing | Fixable region | paper |
| | Toner No. | (° C.) | (%) | (° C.) | gloss |
| Example 1 | 1 | 100 | 1.8 | 55 | 28.2 |
| Example 2 | 2 | 115 | 2.2 | 55 | 27.6 |
| Example 3 | 3 | 125 | 2.4 | 55 | 26.2 |
| Example 4 | 4 | 100 | 1.9 | 25 | 27.2 |
| Example 5 | 5 | 95 | 2.0 | 15 | 26.9 |
| Example 6 | 6 | 120 | 2.2 | 60 | 25.2 |
| Example 7 | 7 | 95 | 2.2 | 20 | 26.5 |
| Example 8 | 8 | 110 | 2.9 | 55 | 26.2 |
| Example 9 | 9 | 120 | 2.2 | 20 | 26.1 |
| Example 10 | 10 | 100 | 2.2 | 55 | 20.3 |
| Example 11 | 11 | 100 | 2.8 | 50 | 15.2 |
| Example 12 | 12 | 100 | 4.9 | 45 | 26.9 |
| Example 13 | 13 | 100 | 6.8 | 40 | 27.2 |
| Example 14 | 14 | 95 | 1.8 | 30 | 20.2 |
| Example 15 | 15 | 110 | 2.3 | 55 | 24.2 |
| Example 16 | 16 | 115 | 2.9 | 55 | 22.9 |
| Example 17 | 17 | 100 | 2.2 | 50 | 28.1 |
| Example 18 | 18 | 110 | 1.9 | 50 | 24.2 |
| Example 19 | 19 | 100 | 1.9 | 35 | 26.9 |
| Example 20 | 20 | 100 | 3.9 | 45 | 26.2 |
| Example 21 | 21 | 100 | 2.2 | 45 | 26.2 |
| Example 22 | 22 | 100 | 1.9 | 55 | 27.4 |
| Example 23 | 23 | 100 | 2.3 | 55 | 26.4 |
| Comparative | comparative 1 | 140 | 2.2 | 55 | 26.2 |
| Example 1 | | | | | |
| Comparative | comparative 2 | 95 | 2.9 | 5 | 26.5 |
| Example 2 | | | | | |
| Comparative | comparative 3 | 135 | 2.4 | 60 | 24.8 |
| Example 3 | | | | | |
| Comparative | comparative 4 | 95 | 2.0 | 5 | 27.1 |
| Example 4 | | | | | |
| Comparative | comparative 5 | 100 | 2.2 | 55 | 13.8 |
| Example 5 | | | | | |
| Comparative | comparative 6 | 100 | 10.8 | 40 | 26.9 |
| Example 6 | | | | | |
| Comparative | comparative 7 | 100 | 2.2 | 10 | 27.8 |
| Example 7 | | | | | |
| Comparative | comparative 8 | 110 | 4.2 | 45 | 13.2 |
| Example 8 | | | | | |

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-210834, filed Dec. 14, 2023, which is hereby incorporated by reference herein in its entirety.

What is claimed is:

1. A toner comprising:
toner particles containing a resin component,
wherein the resin component contains a crystalline vinyl resin having a unit (a) represented by formula (1),
the resin component contains the unit (a) in an amount of 15.0 mass % or more and 40.0 mass % or less based on a mass of the resin component, 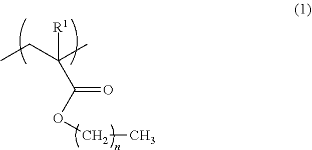
in formula (1), R¹ represents a hydrogen atom or a methyl group, and n represents an integer of 15 to 35,
when the toner particles are subjected to Soxhlet extraction using chloroform for 18 hours to obtain chloroform soluble matter, from which a component having a molecular weight of 2,000 or less is removed by recycling HPLC to obtain chloroform soluble matter W,
for the chloroform soluble matter W, acetonitrile as a poor solvent and chloroform as a good solvent are used while a mobile phase is linearly changed from 100 vol % acetonitrile to 100 vol % chloroform, and an eluted component is subjected to gradient LC analysis,
a plurality of local maximal values are present in a graph in which a horizontal axis represents a chloroform percentage (vol %) in the mobile phase, and a vertical axis represents a signal intensity (μA) of the eluted component detected using a charged particle detector,
when, of a local maximal value with a highest intensity and a local maximal value with a second highest intensity among the plurality of local maximal values, a local maximal value at which the chloroform percentage in the mobile phase is smaller is a local maximal value PA, and a local maximal value at which the chloroform percentage in the mobile phase is larger is a local maximal value PB, a local minimum value with a lowest intensity present between the local maximal value PA and the local maximal value PB is a local minimum value BAB, a chloroform percentage at the local minimum value BAB is VAB vol % (20.0<VAB<95.0), a component whose chloroform percentage in the mobile phase is 20.0 vol % or more and less than VAB vol % is a component A, and a component whose chloroform percentage in the mobile phase is VAB vol % or more and 95.0 vol % or less is a component B,
the resin component contains the component B in an amount of 40.0 mass % or more and 80.0 mass % or less based on the mass of the resin component,
when a content of the unit (a) in the chloroform soluble matter W is WC mass %, and a content of the unit (a) in the component B is WB mass %,
WC and WB satisfy formula (2),
WB/WC≥0.70 (2), and
when a storage elastic modulus of the toner particles at 100° C. is G′(T), and a storage elastic modulus of the component B at 100° C. is G′(B),
G′(T) and G′(B) satisfy formulas (3) and (4),
$$5. \times {10}^{3} Pa \leq {G}^{′} ( T ) \leq 1. \times {10}^{5} Pa \qquad ( 3 )$$
$$2. \times {10}^{3} Pa \leq {G}^{′} ( T ) - {G}^{′} ( B ) \leq 6. \times {10}^{3} Pa . \qquad ( 4 )$$

2. The toner according to claim 1, wherein the component B contains the unit (a) in an amount of 25.0 mass % or more and 50.0 mass % or less based on a mass of the component B.

3. The toner according to claim 1, wherein the component B has a weight-average molecular weight (Mw) of 30,000 or more and 200,000 or less.

4. The toner according to claim 1, wherein the resin component contains the component A in an amount of 10.0 mass % or more and 60.0 mass % or less based on the mass of the resin component.

5. The toner according to claim 1, wherein the resin component contains chloroform insoluble matter in an amount of 3.0 mass % or more and 15.0 mass % or less based on the mass of the resin component.

6. The toner according to claim 1,
wherein the toner particles contain a wax, and
the wax is at least one selected from the group consisting of an ester of an alcohol with a valence of 4 or more and 8 or less and an aliphatic monocarboxylic acid, and
an ester wax of a carboxylic acid with a valence of 4 or more and 8 or less and an aliphatic monoalcohol.

7. The toner according to claim 1, wherein the toner particles have a core-shell structure including a core containing the crystalline vinyl resin and a shell containing an amorphous resin.

8. The toner according to claim 1, wherein the component B has a lactam structure.

9. The toner according to claim 8, wherein the lactam structure contains a unit having a five-membered ring lactam structure.

10. The toner according to claim 1, wherein the crystalline vinyl resin contains a crystalline vinyl resin obtained by polymerizing a vinyl monomer including a (meth)acrylate for introducing the unit (a) and then further reacting another vinyl monomer by hydrogen abstraction reaction.
